(19) United States
(12) Patent Application Publication
(10) Pub. No.: US 2017/0177615 A1
(43) Pub. Date: Jun. 22, 2017

(54) TRANSACTION MANAGEMENT METHOD FOR ENHANCING DATA STABILITY OF NoSQL DATABASE BASED ON DISTRIBUTED FILE SYSTEM

(71) Applicant: WISENUT, INC., Sungnam-si (KR)

(72) Inventors: Hyun Woo LEE, Seoul (KR); Ho Jin PARK, Sungnam-si (KR); Joon Sung KWON, Sungnam-si (KR); Younghyun KWON, Seoul (KR); Dohyun YUN, Incheon (KR); Myung Hyun LEE, Namyangju (KR); Dae Hee KIM, Sungnam-si (KR)

(73) Assignee: WISENUT, INC., Sungnam-si (KR)

(21) Appl. No.: 15/154,485

(22) Filed: May 13, 2016

(30) Foreign Application Priority Data
Dec. 22, 2015 (KR) 10-2015-0183850

(51) Int. Cl. G06F 17/30

(52) U.S. Cl. CPC G06F 17/30194; G06F 17/30115

(57) ABSTRACT

Transaction management methods for enhancing data stability of a NoSQL DB based on a distributed file system are presented. The methods include, for instance: initializing a data storage transaction in which the distributed file system stores a logical file in the NoSQL DB, writing, by the distributed file system, the logical file into an inter-file IF, and moving, by the distributed file system, the inter-file to a physical file of the NoSQL DB when commit on a transaction occurs.

### CROSS-REFERENCE TO RELATED APPLICATION

This application claims priority to Korean Patent Application No. 10-2015-0183850 filed on Dec. 22, 2015 and all the benefits accruing therefrom under 35 U.S.C. §119, the contents of which are incorporated by reference in their entirety.

### BACKGROUND

The present disclosure relates to a method for storing data by use of a distributed file system.

According to recent technology and usage trends, the volume of data is referred to as increasing twofold every forty weeks since 1980's. Such exponential increase in volume demands a new kind of data processing technology. Because a data storage device are ordinarily installed on an individual computer and because a physical storage space has limitations on expansion of the capacity, a method for storing data with a horizontally expandable structure would be better equipped to cope with increasing data volumes. Thus, distributed file systems with horizontal expandability had emerged. Although conventional distributed file systems enabled flexible data expansion through a network I/O that does not depend on a client, such expandable distributed file system does not assure data stability.

### SUMMARY

In accordance with an exemplary embodiment of the present invention, a transaction management method for enhancing data stability of a NoSQL DB based on a distributed file system includes: initializing a data storage transaction in which the distributed file system stores a logical file in the NoSQL DB; writing, by the distributed file system, the logical file into an inter-file IF; and moving, by the distributed file system, the inter-file to a physical file of the NoSQL DB when commit on a transaction occurs.

In accordance with another exemplary embodiment of the present invention, a transaction management method of writing, by a distributed file system, a logical file to a NoSQL DB and making written data valid through commit includes: writing, by a writer of NoSQL, a logical file to an inter-file and a tail; writing, by a commit manager, a writing initial point and size of the inter-file and the number of tails to a commit-temporary-information file when commit occurs; renaming, by the commit manager, a name of the commit-temporary-information file to a commit-information file; and moving and writing, by the writer, the inter-file to a physical file of the NoSQL DB.

### BRIEF DESCRIPTION OF THE DRAWINGS

The drawings are presented to provide an understanding of the technical spirit of the embodiments of the present invention, and the scope of the right of the present invention is not limited thereto. Exemplary embodiments can be understood in more detail from the following description taken in conjunction with the accompanying drawings, in which:

FIG. 1 is a flowchart depicting a transaction management, in accordance with embodiments of the present invention;

FIGS. 2A and 2B represent examples of the process of writing an inter-file, in accordance with embodiments of the present invention;

FIG. 3 is a flowchart depicting the process of recovering data in the case where a process ends abnormally, in accordance with embodiments of the present invention;

FIG. 4 is a flowchart depicting a transaction management method, in accordance with embodiments of the present invention; and

FIG. 5 represents an example for the process of writing an inter-file and a tail, in accordance with embodiments of the present invention.

### DETAILED DESCRIPTION

The present disclosure provides a distributed file system that enhances data stability. Guaranteeing data integrity is one of the most important objectives of the distributed file system, as the data stored in the distributed file system are to be maintained and to be searched and retrieved. Particularly, the distributed file system of the present disclosure enhances the data stability of a NoSQL database (DB) based on the distributed file system. Further, a method of preventing data corruption and recovering data from intact data even when the process included in a transaction ends abnormally is provided. Even further, a method of controlling, within a predictable range, the load of the distributed file system to enhance data stability is provided.

Other objects that the present disclosure does not specify would be additionally considered within a range that may be easily inferred from the detailed description and the effects thereof below.

In describing the present invention, the detailed descriptions of the related known-functions that are obvious to a person skilled in the art and would unnecessarily obscure the subject of the present invention are omitted.

The present invention provides an integrated system for a transaction management, which includes a NoSQL DB (Not only Structured Query Language) enhancing data stability and a distributed file system that stores and searches data in the NoSQL DB. The distributed file system is a client/server based application that allows a computer of a client to access and process data stored on the server as if the data is stored in the computer of the client. In the distributed file system, one or more central servers store files that can be accessed, with proper authorization, by any number of remote clients in the network having respective access to the distributed file system. When a client accesses a file stored on the server, the server sends the client a copy of the file, which is cached on the computer of the client. Since more than one client may access the same data simultaneously, the server have a mechanism in place to organize updates so that the client always receives the most current version of data.

In one embodiment of the present invention, the distributed file system includes: an inter-file production module that produces an inter-file from a logical file until a commit on a transaction occurs; a file block defining module that re-defines a size of a file block of the inter-file as a fixed size for the NoSQL DB; a writer module that stores the logical file into the inter-file or moves and writes the inter-file to physical areas of the NoSQL DB; a monitoring module that monitors whether the commit occurs; a temporary file storage that stores the inter-file temporarily; and a control module that controls the above modules and others.

One embodiment of the present invention provides a transaction management method for enhancing data stability in a NoSQL DB based on a distributed file system. That is, the distributed file system in the same embodiment of the present invention uses a NoSQL DB. A transaction in the distributed file system of embodiments of the present invention is the minimum logical work unit for guaranteeing data integrity when storing data. The transaction in the embodiments of the present invention may be used as a unit for performing an intact logical work (e.g., insertion, deletion, or modification) or as a unit for managing priority control and mutual exclusion amongst a plurality of logical works that many users or application programs generate.

In one embodiment of the present invention, the method prevents data corruption when the process included in the transaction of the distributed file system ends abnormally. To prevent such data corruption, the same embodiment of the present invention operates in order to maintain atomicity for ideal transaction processing. The atomicity means “all or nothing” that is completely or never reflected. The same embodiment of the present invention also minimizes costs to be additionally invested in an aspect of performance. Although achieving the atomicity of database transactions and minimizing the costs may be mutually exclusive, the same embodiment of the present invention provides an optimal solution that may balance both goals of atomicity and cost effectiveness.

In the present disclosure, data corruption indicates that data to write is partially stored. As the distributed file system of the present disclosure is optimized for massive data storage and reading unlike a local file system, so-called random writing may be difficult to perform, due to the fact that, in a distributed file system, a single logical file is split into many physical files and distributed over various locations over a network and more than one replica is generated for data availability and reliability. Accordingly, the difficulty of the random writing in the distributed file system may be analogized to difficulties involved in partially changing and deleting a physically stored file, in which the physically stored file is first deleted and then re-written with an update. Therefore, if a working process stops for any reason during the data writing, the file has a state in which only a portion of data to be written is stored, which is referred to as a data corruption state in the present disclosure. If the corrupted data exists in the NoSQL DB, a program accessing the DB will read the corrupted data and a normal service with the database may not be available.

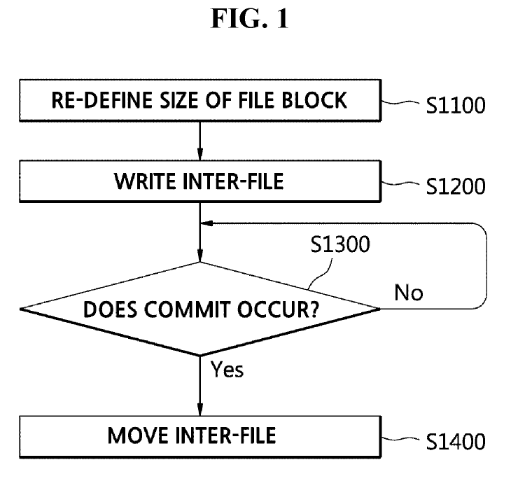

FIG. 1 is a flowchart depicting a transaction management method, in accordance with embodiments of the present invention.

The distributed file system initializes a data storage transaction in which a logical file is stored as the physical file of the NoSQL DB. The data storage transaction is performed by a plurality of processes. In the current embodiment, the distributed file system does not directly store the logical file as the physical file but includes the process of passing through an ‘inter-file’. More details are provided below.

The distributed file system re-defines a size of a file block in step S1100. If the logical file is stored as the inter-file, it would indicate that the system experiences a heavy load. Because the logical file is written into the inter-file and then the inter-file is moved and written into the physical file, the time required may be two or more times longer than a general writing. Moreover, if the size of the logical file increases, an actual load applied to the system increases.

Thus, the present invention splits and stores the logical file. In this case, the spit files are file blocks. For example, if the NoSQL sets the fixed size of the file block to 64 MB in a situation in which a 128 MB logical file should be written, the distributed file system splits the 128 MB logical file into two 64 MB files and writes the split files.

The distributed file system writes the logical file that has been split to have the re-defined size of the file block, into the inter-file IF in step S1200. In one embodiment, the inter-file does not exceed the re-defined size of the file block. Due to that the distributed file system splits the logical file to have the predefined size of the file block and writes it into the inter-file, the inter-file does not exceed the size of the file block. Thus, in the case where the size of the logical file is smaller than the size of the file block, the size of the inter-file may also be smaller than the size of the file block.

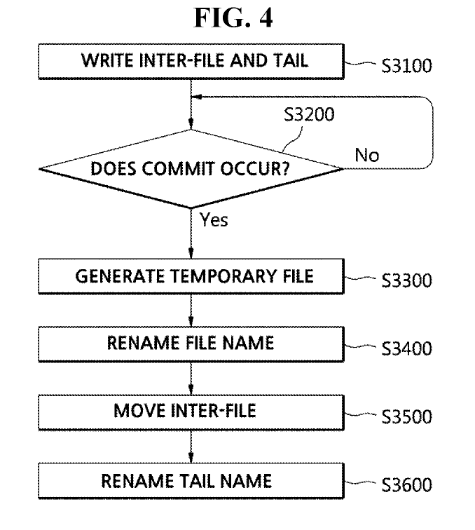

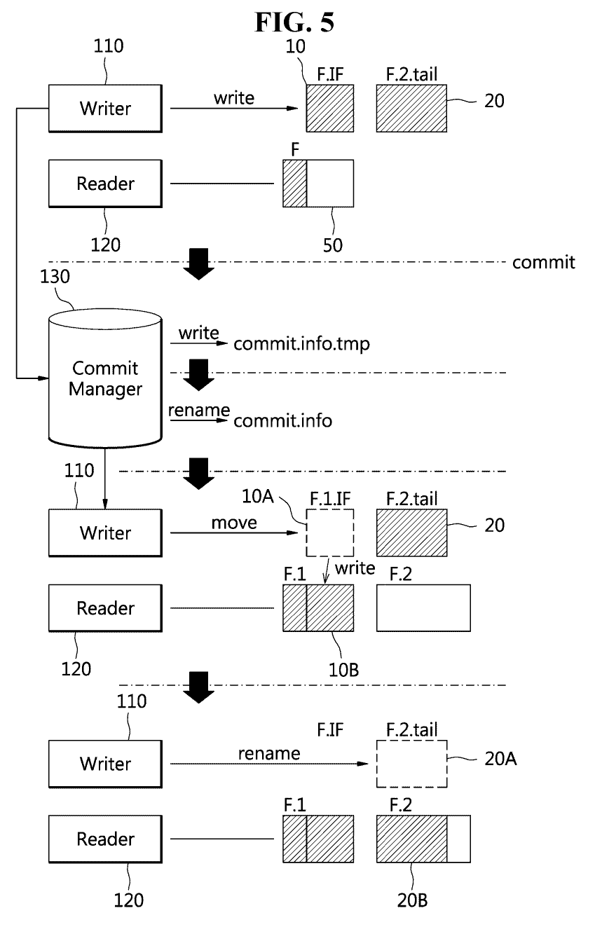

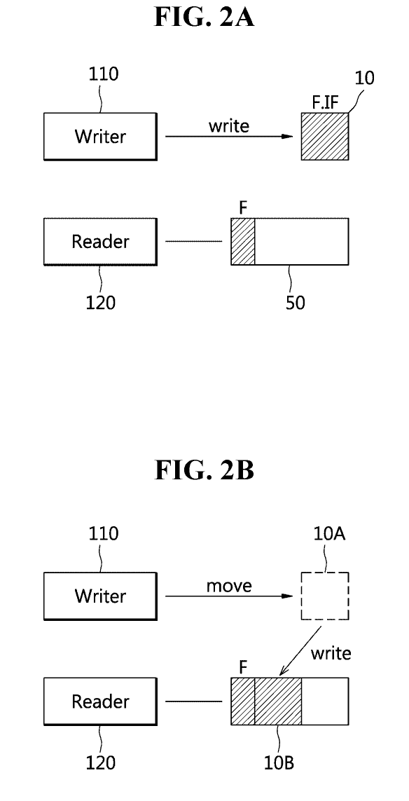

In another embodiment, the distributed file system may split the logical file into the inter-file and a tail, then write them. Even in this case, the size of the inter-file does not exceed the pre-defined size of the file block. However, the size of the tail may not be affected by the size of the file block, because the data corruption problem may be solved by the managing of the inter-file. The inter-file and the tail are described in more detail in the embodiments in FIGS. 4 and 5.

The distributed file system determines whether “commit” has occurred, in step S1300. In one embodiment, the commit is an operation that requests a transaction end when all operations included in a single transaction in distributed transaction processing are performed, a corresponding DB update is written in a work area (storage device) and thus it is determined that the application of the transaction has been completed. The time is referred to as a commit time. When the commit is performed, update data is actually written in a DB (the physical file of a magnetic disk). Unlocking is performed so that another transaction may access the update.

When the commit occurs, the distributed file system initializes the operation of moving the inter-file to the physical file of the NoSQL DB in step S1400. When the inter-file is safely moved and written into the physical file, the data storage transaction ends.

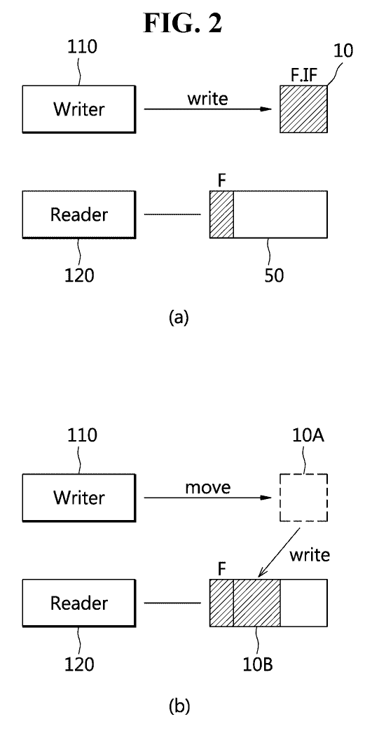

FIGS. 2A and 2B represent examples of the process of writing an inter-file, in accordance with embodiments of the present invention.

As shown in FIG. 2A, a writer 110 of the distributed file system performs the step of storing a logical file F as an inter-file F.IF, and a reader 120 of the distributed file system performs the step of retrieving the logical file F from a physical area 50 of the NoSQL DB. The distributed file system does not store the logical file F directly in the physical area 50 of the NoSQL DB but stores in the inter-file 10.

When the commit occurs, the writer 110 of the distributed file system operates as shown in FIG. 2B. The writer 110 moves and writes an inter-file 10A to the physical area 50 of the DB. When the inter-file 10B generated through movement is written into the physical area 50 of the DB, the data storage transaction ends.

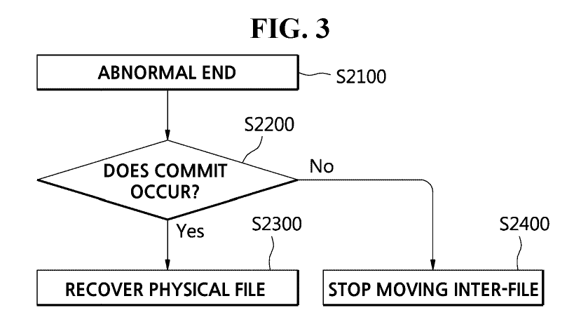

FIG. 3 is a flowchart depicting the process of recovering data in the case where a process ends abnormally, in accordance with embodiments of the present invention.

When the process included in a transaction ends abnormally, there may be a problem with data corruption. In this case, the present invention prevents the data corruption by using two methods below. The two methods are classified based on before and after the commit time.

At first, there is a case where the process included in the transaction ends abnormally after the commit on the transaction occurs. The distributed file system interrupts data corruption by recovering the physical file by using the inter-file. Since there is the inter-file that writing has been completed, a problem with data corruption does not occur when the physical file is recovered by using the inter-file as a reference.

Next, in the case where the process included in the transaction ends abnormally before the commit on the transaction occurs, the distributed file system does not perform the step of moving and storing the inter-file to the physical file of the NoSQL DB. It is difficult to guarantee the integrity of the inter-file because the commit has not occurred. In this case, any data including the inter-file is not written into the physical file of the NoSQL DB. Thus, the problem with data corruption does not occur.

FIG. 4 is a flowchart depicting a transaction management method, in accordance with embodiments of the present invention. In the present embodiment, the concept of a tail in addition to the inter-file is introduced. FIG. 5 represents an example for the process of writing an inter-file and a tail of FIG. 4, in accordance with embodiments of the present invention.

At first, the writer 110 of the NoSQL writes a logical file into an inter-file F.IF 10 and a tail F.2.tail 20 in step S3100. The logical file is split into the inter-file 10 according to the re-defined size of a file block and the remainder is assigned to the tail. That is, a size of the tail may not be limited to the re-defined size of the file block.

The tail is not the inter-file. The tail is not limited to the re-defined size of the file block and is written into the physical file in a different manner. For example, the inter-file is written through the operations of moving and writing after the commit but the tail is written into the physical file through “rename”, not “move and write”.

Moving and writing the inter-file after the commit is to prevent data corruption. To prevent the data corruption of the tail, the current embodiment does not accept a tail that has an unfilled previous block (e.g., inter-file) as valid. As a tail with an unfilled previous block is not accepted and regarded as invalid, writing operations would not be performed for such tail, thus the data corruption of the tail is prevented.

The distributed file system writes the inter-file and the tail and then monitors whether the commit occurs, in step S3200.

When the commit occurs, a commit manager 130 connected to the writer 100 writes commit-temporary-information file commit.info.tmp in step S3300. The commit-temporary-information file may include the writing initial point and size of the inter-file and the number of tails and its example is as follows.

commit.info.tmp

| Files | Initial point | Size | \|tails\| |
|---|---|---|---|
| — | — | — | — |
| F.1.IF | 10 MB | 54 MB | 1 |

The commit manager 130 renames the commit-temporary-information file commit.info.tmp to a commit-information file commit.info in step S3400. An example of the commit-information file is as follows.

commit.info

| Files | Initial point | Size | \|tails\| |
|---|---|---|---|
| — | — | — | — |
| F.1.IF | 10 MB | 54 MB | 1 |

When the rename of the commit-information file is completed, the writer 110 moves and writes 10B an inter-file 10A to the physical file of the NoSQL DB in step S3500. In this process, a load is applied to the system. Theoretically, a write load corresponding to two times the size of the file block may occur. However, the current embodiment previously re-defines the size of the file block and generates the inter-file accordingly. Thus, it dramatically decreases the write load compared to when generating the logical file whose size is difficult to estimate, as the inter-file.

Then, the writer 110 renames 20B the name of the tail 20A in step S3600. Because the writer 110 does not “move and write” the tail to the physical file, there is little load.

When all processes end, the commit manager 130 deletes the commit-information file to specify that a corresponding physical file is in a normal state.

In the case where the process ends abnormally, actions are taken according to the following two cases.

At first, in the case where the process included in a transaction ends abnormally after step S3400, the physical file is recovered by using the inter-file and the tail. The recovery process is performed by the repetition of steps S3500 to S3600. In addition, in the case where the process included in a transaction ends abnormally before step S3400, all writing is invalidated to prevent data corruption.

Although only one instance of a single file has been described in the present disclosure, but executing a plurality of files by a single transaction is also the same. When performing the method according to the present invention as described above after the commit-information file is written, it is possible to significantly enhance data stability.

By the technical solution of the embodiments of the present invention as described above, the present disclosure may provide the transaction management method of the NoSQL DB based on the distributed file system that has enhanced data stability. The embodiments of the present invention enables preventing data corruption and recovering data from intact data even when the process included in the transaction ends abnormally.

The present disclosure also provides a method of appropriately controlling the load of a system simultaneously with enhancing data stability. By re-defining the size of the inter-file for guaranteeing data integrity, the method enables controlling the load that the system should bear, to be within a predictable range.

It should be understood that the distributed file system, the writer, the reader, the commit manager presented in this disclosure are computer programs, which may include a set of program modules, as performed by one or more processor as stored in or loaded on a computer readable storage medium. Also the steps provided in flowcharts may be respective computer programs, program modules, and/or otherwise units of computer-executable instructions.

It should be noted that the effects that are not explicitly mentioned above but are predicted by the technical features of the present invention and are described in the detailed description above, and their tentative effects are handled as described in the present disclosure.

The scope of the present invention is not limited to the description and the expression of the embodiments explicitly explained above. Furthermore, it will be understood that the protection scope of the present invention is not limited by modifications or substitutions that are obvious in the technical field to which the present invention pertains.

We claim:

1. A transaction management method for enhancing data stability of a NoSQL DB based on a distributed file system, the transaction management method comprising:
initializing a data storage transaction in which the distributed file system stores a logical file in the NoSQL DB;
writing, by the distributed file system, the logical file into an inter-file IF; and
moving, by the distributed file system, the inter-file to a physical file of the NoSQL DB when commit on a transaction occurs.

2. The transaction management method of claim 1, wherein said writing further comprises:
re-defining, by the distributed file system, a size of a file block; and
splitting the logical file to enable the inter-file not to exceed the re-defined size of the file block and writing the split file into the inter-file.

3. The transaction management method of claim 1, wherein, in said writing, the distributed file system splits the logical file into the inter-file and a tail and writes the split files, and wherein the inter-file does not exceed a pre-defined size of a file block.

4. The transaction management method of claim 1, wherein said moving further comprises recovering the physical file by using the inter-file in a case where a process included in a transaction ends abnormally after the commit on the transaction occurs.

5. The transaction management method of claim 1, wherein the moving of the inter-file to the physical file of the NoSQL DB is not performed in a case where a process included in a transaction ends abnormally before the commit on the transaction occurs.

6. A transaction management method of writing, by a distributed file system, a logical file to a NoSQL DB and making written data valid through commit, the transaction management method comprising:
writing, by a writer of NoSQL, a logical file to an inter-file and a tail;
writing, by a commit manager, a writing initial point and size of the inter-file and the number of tails to a commit-temporary-information file when commit occurs;
renaming, by the commit manager, a name of the commit-temporary-information file to a commit-information file; and
moving and writing, by the writer, the inter-file to a physical file of the NoSQL DB.

7. The transaction management method of claim 6, further comprising recovering the physical file by using the inter-file and the tail in a case where a process included in a transaction ends abnormally after said renaming.

8. The transaction management method of claim 6, further comprising renaming a name of the tail to make the tail valid.
